(19) United States
(12) Patent Application Publication
(10) Pub. No.: US 2013/0107199 A1
(43) Pub. Date: May 2, 2013

(54) Eyeglasses with Nose Pad Assembly

(71) Applicant: Pen-Wei Chen, Tainan City (TW)

(72) Inventor: Pen-Wei Chen, Tainan City (TW)

(21) Appl. No.: 13/282,539

(22) Filed: Oct. 27, 2011

(51) Int. Cl. G02C 5/12

(52) U.S. Cl. 351/138; 351/139

(57) ABSTRACT

A pair of eyeglasses include a main body and a nose pad assembly. The nose pad assembly includes a connecting bracket connected with the main body, a metallic member connected with the connecting bracket, and a soft nose pad connected with the metallic member. The metallic member has a connecting piece which is protruded outward from the soft nose pad and is covered by the connecting bracket so that the soft nose pad and the connecting bracket are connected by the connecting piece. Thus, the connecting bracket of the nose pad assembly is connected with the main body to attach the nose pad assembly to the main body so that the nose pad assembly is mounted on the main body easily and quickly without needing aid of any screw member.

### BACKGROUND OF THE INVENTION

1. Field of the Invention

The present invention relates to a pair of eyeglasses and, more particularly, to a pair of eyeglasses with a nose pad assembly.

2. Description of the Related Art

A pair of first conventional eyeglasses in accordance with the prior art shown in FIG. 1 comprise a frame 2, a nose pad 1 mounted on the frame 2 and having a top provided with a through hole 10, and a locking screw 3 extended through the through hole 10 of the nose pad 1 and screwed into the frame 2 to attach the nose pad 1 to the frame 2. However, the locking screw 3 is easily loosened from the frame 2 during a long-term utilization so that the nose pad 1 will be detached from the frame 2, thereby causing convenience to the user. In addition, the locking screw 3 is exposed outward from the nose pad 1, thereby decreasing the aesthetic quality of the eyeglasses.

A pair of second conventional eyeglasses in accordance with the prior art shown in FIG. 2 comprise a frame 5, and a nose pad module 4 connected with the frame 5. The nose pad module 4 includes a metallic piece 40 mounted on the frame 5 and having a top provided with at least one through hole 401, at least one locking screw 42 extended through the through hole 401 of the metallic piece 40 and screwed into the frame 5 to attach the metallic piece 40 to the frame 5, and a covering member 41 mounted on the metallic piece 40 to cover the metallic piece 40 and the locking screw 42. However, the locking screw 42 is easily loosened from the frame 5 during a long-term utilization so that the metallic piece 40 will be detached from the frame 5, thereby causing convenience to the user. In addition, the covering member 41 is easily removed from the metallic piece 40 during a long-term utilization so that the metallic piece 40 and the locking screw 42 will be exposed outward the frame 5, thereby decreasing the aesthetic quality of the eyeglasses.

### BRIEF SUMMARY OF THE INVENTION

In accordance with the preferred embodiment of the present invention, there is provided a pair of eyeglasses, comprising a main body and a nose pad assembly connected with the main body. The nose pad assembly includes a connecting bracket connected with the main body, a metallic member connected with the connecting bracket, and a soft nose pad connected with the metallic member. The connecting bracket of the nose pad assembly is formed integrally. The metallic member of the nose pad assembly is formed integrally. The metallic member of the nose pad assembly is sandwiched between the connecting bracket and the soft nose pad. The metallic member of the nose pad assembly is covered completely by the soft nose pad. The metallic member of the nose pad assembly has a top provided with a connecting piece which is disposed at a horizontal state. The connecting piece of the metallic member is protruded outward from the soft nose pad. The connecting piece of the metallic member is inserted into and covered by the connecting bracket. Thus, the connecting piece and the metallic member are covered completely between the connecting bracket and the soft nose pad. The soft nose pad of the nose pad assembly is formed integrally. The soft nose pad and the connecting bracket of the nose pad assembly are connected by the connecting piece of the metallic member.

In accordance with another preferred embodiment of the present invention, there is provided a pair of eyeglasses, comprising a main body and a nose pad assembly connected with the main body. The nose pad assembly includes a connecting bracket combined with the main body, a metallic member connected with the connecting bracket, and a soft nose pad connected with the metallic member. The connecting bracket of the nose pad assembly and the main body are formed integrally. The metallic member of the nose pad assembly is formed integrally. The metallic member of the nose pad assembly is sandwiched between the connecting bracket and the soft nose pad. The metallic member of the nose pad assembly is covered completely by the soft nose pad. The metallic member of the nose pad assembly has a top provided with a connecting piece which is disposed at a horizontal state. The connecting piece of the metallic member is protruded outward from the soft nose pad. The connecting piece of the metallic member is inserted into and covered by the connecting bracket. Thus, the connecting piece and the metallic member are covered completely between the connecting bracket and the soft nose pad. The soft nose pad of the nose pad assembly is formed integrally. The soft nose pad and the connecting bracket of the nose pad assembly are connected by the connecting piece of the metallic member.

According to the primary advantage of the present invention, the connecting bracket of the nose pad assembly is connected with the main body to attach the nose pad assembly to the main body so that the nose pad assembly is mounted on the main body easily and quickly without needing aid of any screw member.

According to another advantage of the present invention, the connecting piece and the metallic member are covered completely between the connecting bracket and the soft nose pad to enhance the aesthetic quality of the nose pad assembly.

According to a further advantage of the present invention, the metallic member is hidden between the connecting bracket and the soft nose pad so that the nose pad assembly is operated safely.

According to a further advantage of the present invention, the soft nose pad and the connecting bracket of the nose pad assembly are connected solidly and stably by the connecting piece of the metallic member so that the nose pad assembly has a solid and stable structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a pair of first conventional eyeglasses in accordance with the prior art.

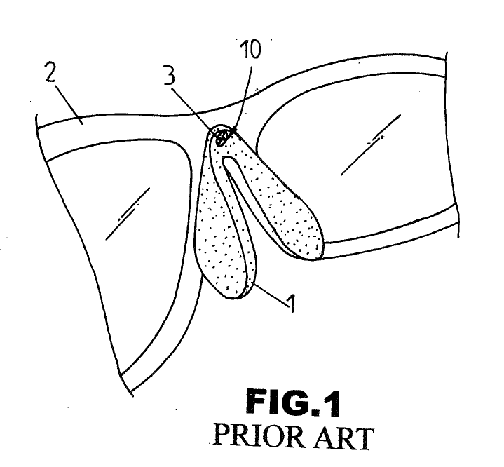

FIG. 2 is a partially perspective view of a pair of second conventional eyeglasses in accordance with the prior art.

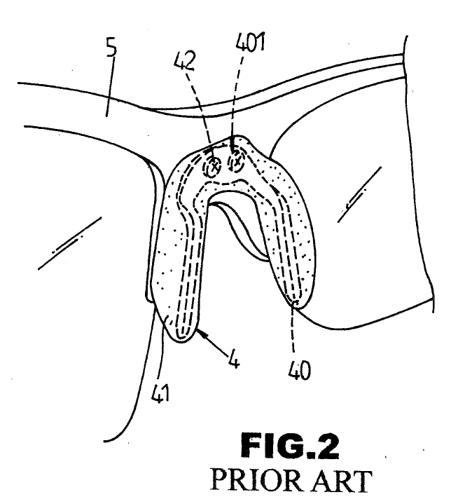

FIG. 3 is a perspective view of a pair of eyeglasses in accordance with the preferred embodiment of the present invention.

FIG. 4 is a perspective view of a nose pad assembly of the eyeglasses as shown in FIG. 3.

FIG. 5 is a front exploded view of the nose pad assembly of the eyeglasses as shown in FIG. 4.

FIG. 6 is a rear cross-sectional view of the nose pad assembly of the eyeglasses as shown in FIG. 4.

FIG. 7 is a partially perspective view of a pair of eyeglasses in accordance with another preferred embodiment of the present invention.

### DETAILED DESCRIPTION OF THE INVENTION

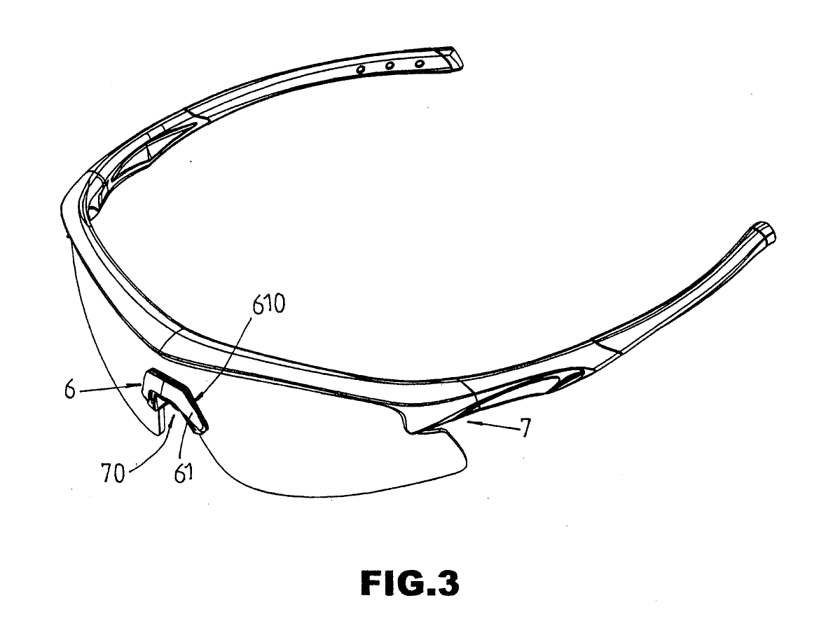

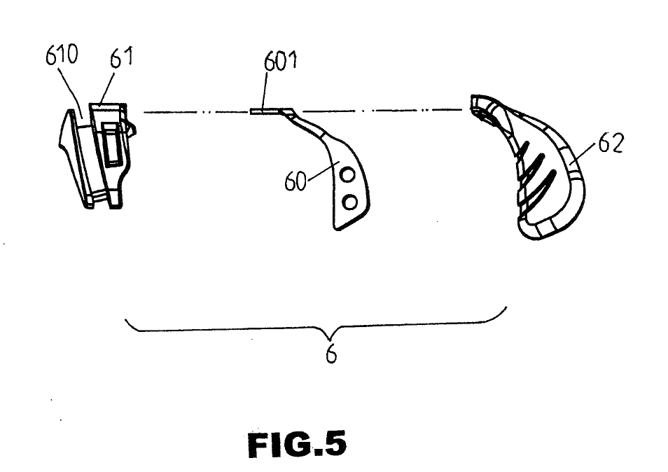

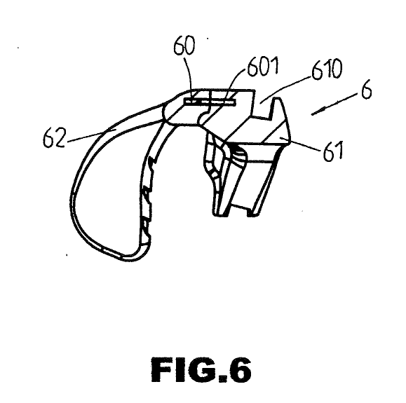

Referring to the drawings and initially to FIGS. 3-6, a pair of eyeglasses in accordance with the preferred embodiment of the present invention comprise a main body 7 and a nose pad assembly 6 connected with the main body 7.

The main body 7 has side provided with a nose support portion 70. Preferably, the main body 7 is a frameless body.

The nose pad assembly 6 exists individually and is detachable from the main body 7. The nose pad assembly 6 includes a connecting bracket 61 connected with the main body 7, a metallic member 60 connected with the connecting bracket 61, and a soft nose pad 62 connected with the metallic member 60.

The connecting bracket 61 of the nose pad assembly 6 is formed integrally. The connecting bracket 61 of the nose pad assembly 6 has a side provided with a connecting groove 610 mounted on the nose support portion 70 of the main body 7.

The metallic member 60 of the nose pad assembly 6 is formed integrally and has a profile matching that of the soft nose pad 62. The metallic member 60 of the nose pad assembly 6 is sandwiched between the connecting bracket 61 and the soft nose pad 62 and is covered completely by the soft nose pad 62. The metallic member 60 of the nose pad assembly 6 has a top provided with a connecting piece 601 which is disposed at a horizontal state. The connecting piece 601 of the metallic member 60 is protruded outward from the soft nose pad 62. The connecting piece 601 of the metallic member 60 is inserted into and covered by the connecting bracket 61. Thus, the connecting piece 601 and the metallic member 60 are covered completely between the connecting bracket 61 and the soft nose pad 62.

The soft nose pad 62 of the nose pad assembly 6 is formed integrally and covers the metallic member 60. The soft nose pad 62 and the connecting bracket 61 of the nose pad assembly 6 are connected by the connecting piece 601 of the metallic member 60.

Accordingly, the connecting bracket 61 of the nose pad assembly 6 is connected with the main body 7 to attach the nose pad assembly 6 to the main body 7 so that the nose pad assembly 6 is mounted on the main body 7 easily and quickly without needing aid of any screw member. In addition, the connecting piece 601 and the metallic member 60 are covered completely between the connecting bracket 61 and the soft nose pad 62 to enhance the aesthetic quality of the nose pad assembly 6. Further, the metallic member 60 is hidden between the connecting bracket 61 and the soft nose pad 62 so that the nose pad assembly 6 is operated safely. Further, the soft nose pad 62 and the connecting bracket 61 of the nose pad assembly 6 are connected solidly and stably by the connecting piece 601 of the metallic member 60 so that the nose pad assembly 6 has a solid and stable structure.

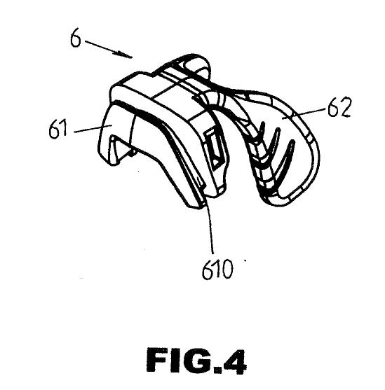

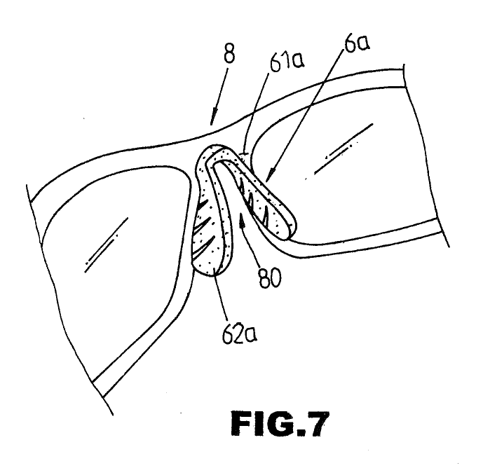

Alternatively, referring to FIG. 7 with reference to FIGS. 4-6, a pair of eyeglasses in accordance with another preferred embodiment of the present invention comprise a main body 8 and a nose pad assembly 6a connected with the main body 8.

The main body 8 has side provided with a nose support portion 80. Preferably, the main body 8 is a frame-type body.

The nose pad assembly 6a includes a connecting bracket 61a combined with the main body 8, a metallic member 60 (see FIGS. 4-6) connected with the connecting bracket 61a, and a soft nose pad 62a connected with the metallic member 60.

The connecting bracket 61a of the nose pad assembly 6a and the nose support portion 80 of the main body 8 are formed integrally.

The metallic member 60 of the nose pad assembly 6 is formed integrally and has a profile matching that of the soft nose pad 62a. The metallic member 60 of the nose pad assembly 6a is sandwiched between the connecting bracket 61a and the soft nose pad 62a and is covered completely by the soft nose pad 62a. The metallic member 60a of the nose pad assembly 6a has a top provided with a connecting piece 601 which is disposed at a horizontal state. The connecting piece 601 of the metallic member 60 is protruded outward from the soft nose pad 62a. The connecting piece 601 of the metallic member 60 is inserted into and covered by the connecting bracket 61a. Thus, the connecting piece 601 and the metallic member 60 are covered completely between the connecting bracket 61a and the soft nose pad 62a.

The soft nose pad 62a of the nose pad assembly 6a is formed integrally and covers the metallic member 60. The soft nose pad 62a and the connecting bracket 61a of the nose pad assembly 6a are connected by the connecting piece 601 of the metallic member 60.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pair of eyeglasses, comprising:
a main body; and
a nose pad assembly connected with the main body;
wherein the nose pad assembly includes:
a connecting bracket connected with the main body;
a metallic member connected with the connecting bracket; and
a soft nose pad connected with the metallic member;
the connecting bracket of the nose pad assembly is formed integrally;
the metallic member of the nose pad assembly is formed integrally;
the metallic member of the nose pad assembly is sandwiched between the connecting bracket and the soft nose pad;
the metallic member of the nose pad assembly is covered completely by the soft nose pad;
the metallic member of the nose pad assembly has a top provided with a connecting piece which is disposed at a horizontal state;
the connecting piece of the metallic member is protruded outward from the soft nose pad;
the connecting piece of the metallic member is inserted into and covered by the connecting bracket;
the connecting piece and the metallic member are covered completely between the connecting bracket and the soft nose pad;
the soft nose pad of the nose pad assembly is formed integrally;
the soft nose pad and the connecting bracket of the nose pad assembly are connected by the connecting piece of the metallic member.

2. The eyeglasses of claim 1, wherein
the main body is a frameless body; and
the nose pad assembly exists individually and is detachable from the main body.

3. A pair of eyeglasses, comprising:
a main body; and
a nose pad assembly connected with the main body;
wherein the nose pad assembly includes:
a connecting bracket combined with the main body;
a metallic member connected with the connecting bracket; and
a soft nose pad connected with the metallic member;
the connecting bracket of the nose pad assembly and the main body are formed integrally;
the metallic member of the nose pad assembly is formed integrally;
the metallic member of the nose pad assembly is sandwiched between the connecting bracket and the soft nose pad;
the metallic member of the nose pad assembly is covered completely by the soft nose pad;
the metallic member of the nose pad assembly has a top provided with a connecting piece which is disposed at a horizontal state;
the connecting piece of the metallic member is protruded outward from the soft nose pad;
the connecting piece of the metallic member is inserted into and covered by the connecting bracket;
the connecting piece and the metallic member are covered completely between the connecting bracket and the soft nose pad;
the soft nose pad of the nose pad assembly is formed integrally;
the soft nose pad and the connecting bracket of the nose pad assembly are connected by the connecting piece of the metallic member.
